(19) United States
(12) Patent Application Publication
(10) Pub. No.: US 2009/0241557 A1
(43) Pub. Date: Oct. 1, 2009

(54) Hydrogen storage installation for feeding fuel cell and motor vehicle comprising same

(76) Inventors: Alain Ravex, Meylan (FR); Laurent Allidieres, Uriage Les Bains (FR)

Correspondence Address: AIR LIQUIDE;Intellectual Property, 2700 POST OAK BOULEVARD, SUITE 1800, HOUSTON, TX, 77056, US

(21) Appl. No.: 10/584,786

(22) PCT Filed: Dec. 22, 2004
(86) PCT No.: PCT/FR04/50745

§ 371 Date: Jun. 28, 2006

(30) Foreign Application Priority Data
Jan. 12, 2004 (FR) 0450069

(51) Int. Cl. F17C 9/02; F17C 13/08

(52) U.S. Cl. 62/50.2; 62/53.2

(57) ABSTRACT

The invention concerns a hydrogen storage installation for feeding fuel cell (11) in particular for motor vehicles, comprising a liquid hydrogen tank including a light insulation shell made of foam (2) incorporating at least one metal screen (3, 4), and a gaseous hydrogen discharge circuit (8) connected to the hydrogen input of the fuel cell (11) and having at least one portion (14; 13) in thermal exchange relationship with the screen (3, 4), the latter being likewise placed in thermal exchange relationship with the cold part (16) of an electrical refrigerating machine (15) supplied with electric current by the fuel cell (11). The invention is applicable to motor vehicles powered by electric power of a fuel cell.

The present invention relates to hydrogen storage installations, in particular for feeding a fuel cell, more particularly for automobile applications.

For onboard applications, hydrogen, used for feeding internal combustion engines and/or fuel cells used for or participating in the propulsion or development of onboard electrical power, can be stored in gaseous form or in liquid form.

Storage in gaseous form calls for very high pressures resulting in an increase in the weight of fuel tanks and a set configuration thereof.

Storage in liquid form permits storage under low pressure, close to atmospheric pressure, but requires perfect insulation in order to keep the liquid in the tank at a temperature close to 20 K. Up to now, tanks have had to be used that are equally sophisticated and have a set configuration, with a vacuum jacket, which considerably increase manufacturing costs.

The object of the present invention is to provide a lower cost storage installation, enabling a light tank to be used provided with less efficient insulation and which is therefore simpler to employ and economical to construct, but which however guarantees the maintenance of suitable low temperatures at pressures close to atmospheric pressure, so as to benefit from a liquid cryogenic fluid.

To this end, according to the invention, the installation comprises: a liquid hydrogen tank having an insulating jacket made of cellular material incorporating at least one first metal screen; a pipeline for extracting liquid hydrogen; a circuit for discharging gaseous hydrogen, connected to the hydrogen inlet of a fuel cell and having at least one portion in a heat exchange relationship with the first screen; and an electrical refrigerating machine connected to the fuel cell and having at least one cold part in a heat exchange relationship at least with the first screen.

According to other features of the invention:
the tank has at least one second thermal screen also in a heat exchange relationship with a portion of the circuit for discharging gaseous hydrogen;
at least one of the thermal screens is composed of a sandwich assembly of at least two metal plates advantageously having zones deformed into a trough constituting at least one part of the portions of the circuit for discharging gaseous hydrogen in a heat exchange relationship with the corresponding thermal screen.

The present invention also relates to a vehicle having a hydrogen storage installation of the above type, the fuel cell advantageously participating in the propulsion of said vehicle.

Other features and advantages of the present invention will become apparent from the following description of embodiments given by way of illustration but in no way limiting, made in relation to the appended drawings, in which:

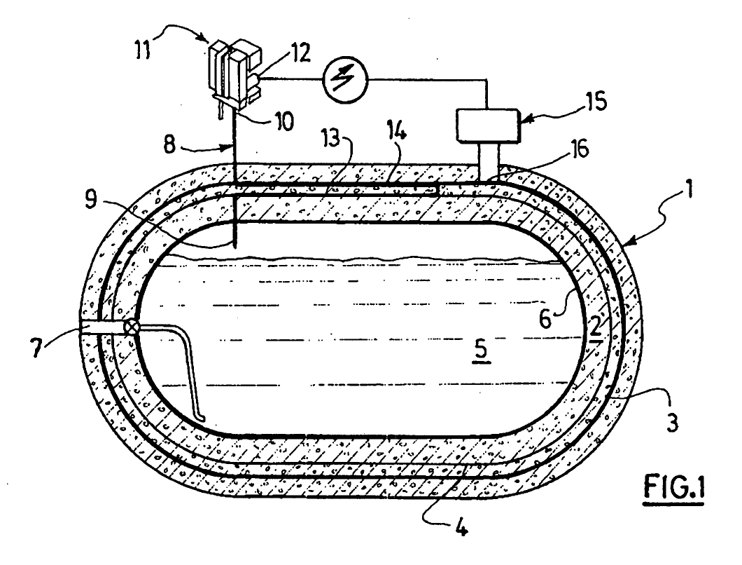

FIG. 1 is a diagrammatic view in vertical section for the tank of an installation according to the invention; and

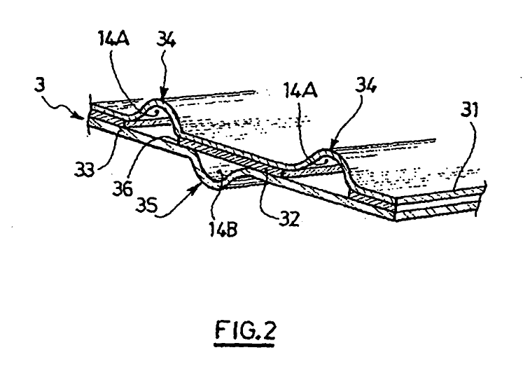

FIG. 2 is a perspective diagrammatic view and a partial section of an embodiment of a thermal screen according to the invention.

The installation shown diagrammatically in FIG. 1 comprises a tank, generally denoted by the reference 1, of any shape, of which the thick wall consists of a mass formed of multilayer thermoplastic foam, in the form of a shell with inherent stability, generally denoted by the reference 2, in which at least one, advantageously at least 2, outer thermal screens 3 and inner thermal screens 4 are buried. The material of the foam is advantageously a closed-cell polyurethane foam. The material of the screens is advantageously a conducting metal alloy based on copper or aluminum.

The inner screen 4 may be arranged so as to act as a pressure-resistant envelope. In this case, the inner insulating layer of the insulating mass 2 is in direct contact with the liquid hydrogen in the inner cavity 5 of the tank 1, which can make it possible to avoid installing an inner metal envelope such as 6. The tank 1 is conventionally provided with a pipeline 7 for discharging liquid hydrogen, provided with a valve, passing through the thickness of the foam.

According to one feature of the invention, the tank 1 additionally includes a circuit 8 for discharging gaseous hydrogen located above the liquid hydrogen mass, having thus an inner end 9 emerging in the upper part of the tank and an outer end 10 connected to the hydrogen inlet of a fuel cell 11 providing electrical power at the terminals 12. The circuit 8 advantageously includes a pressure relief valve for venting gaseous hydrogen to air when the pressure in the cavity 5 reaches a set maximum value, typically approximately 3.5 bar.

The circuit 8 includes an inner portion 13 running along the inner screen 4, in a heat exchange relationship with the latter, as well as a downstream portion 14 running along the outer screen 3 and in a heat exchange relationship with the latter.

According to another feature of the invention, a refrigerating machine 15, for example of the Stirling or Brighton pulse-tube type, supplied with electrical power available at the output terminals 12 of the cell 11, is associated with the tank 1 (advantageously mounted on the latter), with its cold end 16 entering the foam jacket of the reservoir 1, so as to come into a heat exchange relationship with at least the outer screen 3. It will be understood from the previous description that the thermal screens 3 and 4 are permanently cooled by the gaseous hydrogen flow discharged by the circuit 8 and, moreover, at least temporarily, by the refrigerating machine 15 making use of the electrical power “offered” by the gaseous hydrogen evaporating in the tank 1 and feeding the fuel cell 11.

The installation according to the invention therefore makes it possible to easily produce a tank 1 with a free form (not being subjected to pressure), and therefore capable of being best incorporated in the spaces available in vehicles, with low manufacturing costs (for example by simply spraying foam instead of meticulously applying many multilayers by known techniques) and avoiding long and expensive conventional operations of creating a vacuum and verifying that a vacuum is maintained. Moreover, by reason of the absence of a vacuum, the thermal performance of the tank is not significantly degraded in the case of a localized impact, in this way ensuring increased safety of vehicles.

The thermal screens 3 and 4 are typically made by assembling thin aluminum and/or copper plates. According to one feature of the invention, as shown in FIG. 2, the thermal screen, in this case the screen 3, consists of an assembly of three metal plates 31, 32 and 33, at least one of the outer plates 31 and/or 33 being embossed so as to have longitudinal deformations in the form of a trough 34, 35 delimiting, with the intermediate plate 32 or with the other outer plate 33 in the case where the intermediate plate 32 has longitudinal recesses 36, channels 14A, 14B constituting at least partly the portion 14 of the circuit 8 for discharging gaseous hydrogen. This arrangement prevents junction problems between the separate tubes and the thermal screens, greatly promotes heat exchange relationships between the circulating gas and the screen, and stiffens the latter.

Although the invention has been described in relation to particular embodiments, it is not limited thereby but is open to modifications and variations that will be apparent to a person skilled in the art within the context of the following claims.

1-9. (canceled)

10. A hydrogen storage installation comprising:
a) a liquid hydrogen tank (1) having an insulating jacket (2) made of cellular material incorporating at least one first metal screen (3),
b) a pipeline (7) for extracting liquid hydrogen,
c) a circuit (8) for discharging gaseous hydrogen, connected to the hydrogen inlet of a fuel cell (11) and having at least one portion (14) in a heat exchange relationship with the first screen,
d) an electrical refrigerating machine (15) connected to the fuel cell (11) and having at least one cold part (16) in a heat exchange relationship at least with the first screen (3).

11. The installation of claim 10, wherein the tank has at least one second thermal screen (4) also in a heat exchange relationship with a portion (13) of the discharge circuit (8).

12. The installation of claim 11, wherein the second thermal screen (4) is positioned inside the first thermal screen (3).

13. The installation of claim 12, wherein the second thermal screen (4) is an envelope with inherent stability.

14. The installation of claim 10, wherein the insulating jacket (2) consists of at least two layers of polyurethane foam.

15. The installation of claim 11, wherein at least one of the first and second thermal screens (3; 4) is composed of an assembly of at least two metal plates (31, 32).

16. The installation of claim 15, wherein at least one part (14A; 14B) of the portion (14; 13) of the circuit (8) in a heat exchange relationship with the screen (3; 4) is formed of zones deformed into a trough (34; 35) of said plates (31; 32).

17. A vehicle comprising a hydrogen storage installation of claim 10.

18. The vehicle of claim 17, wherein the fuel cell participates in the propulsion of the vehicle.
